(19) United States
(12) Patent Application Publication
(10) Pub. No.: US 2015/0081907 A1
(43) Pub. Date: Mar. 19, 2015

(54) MECHANISM FOR OPTIMIZED, NETWORK-AWARE CLOUD BURSTING

(71) Applicant: Alcatel Lucent, Paris (FR)

(72) Inventors: Michael Scharf, Stuttgart (DE); Volker Hilt, Waiblingen (DE); Thomas Voith, Kornwestheim (DE)

(73) Assignee: Alcatel Lucent, Paris (FR)

(21) Appl. No.: 14/027,394

(22) Filed: Sep. 16, 2013

(51) Int. Cl. H04L 29/08

(52) U.S. Cl. CPC H04L 67/10
USPC 709/226

(57) ABSTRACT

Various exemplary embodiments relate to a method for scaling out a cloud application, the method including: receiving a virtual private network (VPN) scale out request at a network management system (NMS), the scale out request including communication requirements from a cloud computing manager; determining the value of communication parameters corresponding to the communication requirements for a set of potential VPN endpoints; determining that only a portion of the set of potential VPN endpoints meet the communication requirements based upon the communication parameters; and sending an indication to the cloud manager that only a portion of the set of potential VPN endpoints meet the communication requirements.

### TECHNICAL FIELD

Various exemplary embodiments disclosed herein relate generally to network management.

### BACKGROUND

Cloud-based applications are usually comprised of multiple virtual machines (VMs), which each run an instance or component of the application. The sum of all VMs together provides the cloud application to the customer. Similarly, enterprise applications hosted in data centers (private or public) consist of multiple application instances that together provide the application to customers. All instances of an application are connected so that they can communicate among each other and with their customers. If the application instances run at different locations, e.g., in different data centers, the communication is typically realized over a Virtual Private Network (VPN). There are many VPN technologies that can interconnect operating at different protocol layers. For instance, a widely used layer 2 VPN technology (L2VPN) is Virtual Private LAN Service (VPLS). There are also equivalent Layer 3 VPN solutions (L3VPN).

If demand on an application increases, it may be desirable to scale the application up and create new application instances to handle the additional load (typically demand increases, scaling up is typically done after some quality or quantity threshold is passed). These instances may be located in the same data center as other application instances. They can also be located in a different data center to extend the pool of resources available to the application or to provide improved load balancing, geo-redundancy or shorter distances to end users. VM instances in a different data center are connected to existing instances through a VPN, which enables all application instances to communicate. Cloud application scale out into another data center is often called cloud bursting.

### SUMMARY

A brief summary of various exemplary embodiments is presented below. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various exemplary embodiments relate to a method for scaling out a cloud application, the method including: receiving a virtual private network (VPN) scale out request at a network management system (NMS), the scale out request including communication requirements from a cloud computing manager; determining the value of communication parameters corresponding to the communication requirements for a set of potential VPN endpoints; determining that only a portion of the set of potential VPN endpoints meet the communication requirements based upon the communication parameters; and sending an indication to the cloud manager that only a portion of the set of potential VPN endpoints meet the communication requirements.

Various exemplary embodiments relate to a network management system (NMS) for configuring a virtual private network (VPN) for a scale out of a cloud application, the NMS including: a network interface; a memory; and a processor in communication with the memory, the processor being configured to: receive a VPN scale out request at a network management system (NMS), the scale out request including communication requirements from a cloud computing manager; determine the value of communication parameters corresponding to the communication requirements for a set of potential VPN endpoints; determine that only a portion of the set of potential VPN endpoints meet the communication requirements based upon the communication parameters; and send an indication to the cloud manager that only a portion of the set of potential VPN endpoints meet the communication requirements.

Various exemplary embodiments relate to a non-transitory machine-readable storage medium encoded with instructions for execution by a network management system for scaling out a cloud application, the medium including: instructions for receiving a virtual private network (VPN) scale out request at a network management system (NMS, the scale out request including communication requirements from a cloud computing manager; instructions for determining the value of communication parameters corresponding to the communication requirements for a set of potential VPN endpoints; instructions for determining that only a portion of the set of potential VPN endpoints meet the communication requirements based upon the communication parameters; and instructions for sending an indication to the cloud manager that only a portion of the set of potential VPN endpoints meet the communication requirements.

### BRIEF DESCRIPTION OF THE DRAWINGS

In order to better understand various exemplary embodiments, reference is made to the accompanying drawings, wherein:

FIG. 1 illustrates an overview of a VPN that interconnects different VPN endpoints;

FIG. 2 illustrates an embodiment of the cloud scale out management system;

FIG. 3 illustrates another embodiment of the cloud scale out management system;

FIG. 4 illustrates a simple example of how a cloud scale out of VMs already running a cloud application at one VPN endpoint may be connected to a new, remote site over the VPN 105 that has to be expanded accordingly;

FIG. 5A illustrates an embodiment of a more complex example of a cloud scale out;

FIG. 5B illustrates the case where all of the communication requirements are met by the candidate VPN endpoints;

FIG. 5C illustrates the case where all of the communication requirements are met by the candidate VPN endpoints;

FIG. 6 illustrates the communication requirements for a cloud application using a VPN network;

FIG. 7 illustrates the communication requirements for a cloud application using a VPN network;

FIG. 8 illustrates moving an existing instance of a cloud application from one existing VPN endpoint to another existing VPN endpoint;

FIG. 9 illustrates an example message sequence for a cloud scale out;

FIG. 10 illustrates a flow diagram for a method of scaling out VPN connections for a cloud application; and

FIG. 11 illustrates a hardware diagram of an exemplary cloud node.

To facilitate understanding, identical reference numerals have been used in the Figures and the text to designate elements having substantially the same or similar structure or substantially the same or similar function.

Herein, various embodiments are described more fully by the Figures and the Detailed Description. Nevertheless, the inventions may be embodied in various forms and are not limited to the specific embodiments that are described in the Figures and Detailed Description.

### DETAILED DESCRIPTION

The description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Additionally, the term, “or,” as used herein, refers to a non-exclusive or (i.e., and/or), unless otherwise indicated (e.g., “or else” or “or in the alternative”). Also, the various embodiments described herein are not necessarily mutually exclusive, as some embodiments can be combined with one or more other embodiments to form new embodiments. As used herein, the terms “context” and “context object” will be understood to be synonymous, unless otherwise indicated.

A challenge for cloud scale out is to select the data center to scale out to while meeting connectivity requirements of the application. In many cases, there are multiple data centers available into which a cloud application may extend. The application provider may need to select one of these data centers for the creation of new application instances. This selection decision may be based on requirements such as: delay between application instance, bandwidth requirements, networking costs, geographical limitations, provider policies, and the like.

Because each site in the existing VPN may be a potential attachment point for the new instances; a selection mechanism may estimate an optimum data center out of a set of candidate data centers into which to scale and a set of potential attachments points for the VPN. This selection takes into account the existing VPN endpoints of the VPN as well as the application requirements, which are not necessarily fully known or well-defined. Furthermore, additional VPN endpoints could be added to the VPN to attach new instances.

Advantageously, cloud scale out based on network conditions, network topology and current network status do not require cloud operators to manually select the data center to be used for cloud bursting (e.g., using local knowledge or descriptive names such as “US East Coast”). Though in the following description the term VPN endpoint refers to a data center, one skilled in the art shall appreciate that a VPN endpoint may be any suitable endpoint such as any facility or customer premises that may provide data storage, processing, user data and/or authentication, etc. However, the VPN endpoints may include other resources such as data storage, processing, user data and/or authentication, etc.

Below a system and method for selection of data centers for cloud scale out is described in detail. Such a system may automatically determine the costs for the attachment of each candidate data center considering the current network status, existing VPN sites, candidate data center locations, application provider policies, etc. for use in determining which candidate data center to select. The system may also use parameters that are not network related, e.g., CPU load, memory usage in the candidate VPN endpoint, etc. The system may recommend or automatically select a candidate VPN endpoint that meets the given requirements. If no candidate VPN endpoint meets the all of the requirements, the system may suggest changes to the current VM arrangement such that a matching VPN endpoint may be found that meets the requirements or a list of the estimated best candidates that meet some of the requirements may be provided. Also, the system may inform the user if none of the candidates may be used for cloud scale out of the given application.

The system may calculate the attachment costs for each candidate VPN endpoint. Each cost type may be considered separately if corresponding constraints will be considered during scale out of the VPN. Examples of cost types may include network delay, network bandwidth or packet loss rates. The calculation may include the automated selection of the estimated best attachment point for each candidate VPN endpoint to the current VPN topology and the calculation of costs based on this attachment point. The system may use a priori configuration knowledge as to which target sites may be available and how they may be addressed (e.g., by a corresponding identifier, by an address, by an abstract name, by a region or zone, or by geographic coordinates). Further, it may be required to map the identifiers visible to an application provider (i.e., user-related identifiers) to identifiers used internally in the network (e.g., typically addresses) because the application provider and the network may use different identifiers for the same VPN endpoint.

The calculated costs may then be matched to specific communication requirements of a cloud application (e.g., maximum delay between application instances, minimum bandwidth between application instances, maximum loss between application instances). Based on this calculation for all or a portion of the cost types, the system categorizes the candidate VPN endpoints into three classes:
No match: the candidate VPN endpoint does not meet the application communication requirements and cannot be used to support cloud scale out for the application, i.e., no VM within the existing VPN would be able to communicate with a VM in the candidate VPN endpoint meeting the given communication requirements. For example, if a maximum delay has been defined as a requirement, a no match condition is determined when no VM in the existing VPN is able to communicate with a VM in the candidate VPN endpoint under the given delay constraints.
Full match: the VPN endpoint meets the communication requirements for all the nodes in the existing VPN, i.e., all VMs in the existing VPN would be able to communicate with a VM in new VPN endpoint meeting the given communication requirements. For example, if a maximum delay has been specified, all nodes in the existing VPN can communicate with a VM in the candidate VPN endpoint with a delay lower than the maximum delay.
Partial match: some of the VMs in the current VPN meet the specified requirements but not all. For example, if a maximum delay has been defined, some, but not all, VMs in the current VPN are able to communicate with a VM in the candidate VPN endpoints with a delay less than the maximum delay.

The system may perform the above categorization for all cost types and combine the results. If one or multiple candidate VPN endpoints are in the full match category for all costs types, these VPN endpoints are selected. A prioritization algorithm may be used to rank candidate VPN endpoints based on the minimum costs and the highest ranked VPN endpoint (or the highest ranked N if multiple VPN endpoints should be used) is recommended. In this case, the cloud scale out using the chosen VPN endpoints may meet the specified communication requirements and provide the best performance possible under the given cost metric and network conditions.

If no full match VPN endpoint is found, the system calculates the set of existing VMs in the VPN and candidate VPN endpoints that meet the defined communication requirements. This information may be provided to the cloud management system. The indication of such a partial match may use identifier, addresses, or other data or terms like city names, regions or zones in order to describe what destinations fulfill the communication requirements, and to which degree.

Based on the calculated set of VMs and candidate VPN endpoints, the VM management system may migrate VMs running instances of the cloud application that do not meet the communication requirements to sites that meet the communication requirements. The VM management system may also decide that the communication requirements do not apply to all VMs (e.g., only those VMs that run a back-end data base) and arrange the VMs such that the critical VMs are in locations that meet the given communication requirements. Through this interaction with the VM management layer, the system may enable cloud scale out even in cases where the original VM arrangement would not allow a cloud scale out or only allow it with degraded performance.

In some embodiments, if no candidate VPN endpoint fulfills the communication requirements, the request is not served and a corresponding error message is returned.

To improve the accuracy of the cost calculation and to further automate the selection in the case that not all VMs meet the given requirements, it may be beneficial to consider the traffic matrix in the VPN. In this embodiment of the system, the costs for the attachment of a candidate VPN endpoint may be calculated based on the traffic matrix for the VPN. The traffic matrix for the VPN defines the characteristic of traffic exchanged between the VM types used by an application. For example, an application may include load balancer VMs that communicate with the public Internet, Web-server VMs that communicate with the load balancer VMs and back-end data base VMs that communicate with the Web servers. The traffic matrix for this application will describe the traffic exchanged between these VM types. If the system knows the traffic matrix and the types of the VMs in the existing VPN and the type of the VMs to be established in the candidate VPN endpoint, the system may create an estimate of the network costs with high accuracy. Knowing the traffic matrix and the VM types may also enable the system to determine if a partial match will meet the requirements of an application and which VMs need to be moved.

In one embodiment, the network is managed by a network management system (NMS). The NMS has knowledge of the network topology and may determine the required cost parameters. The NMS may also change the VPN by reconfiguration of the network elements (e.g., routers).

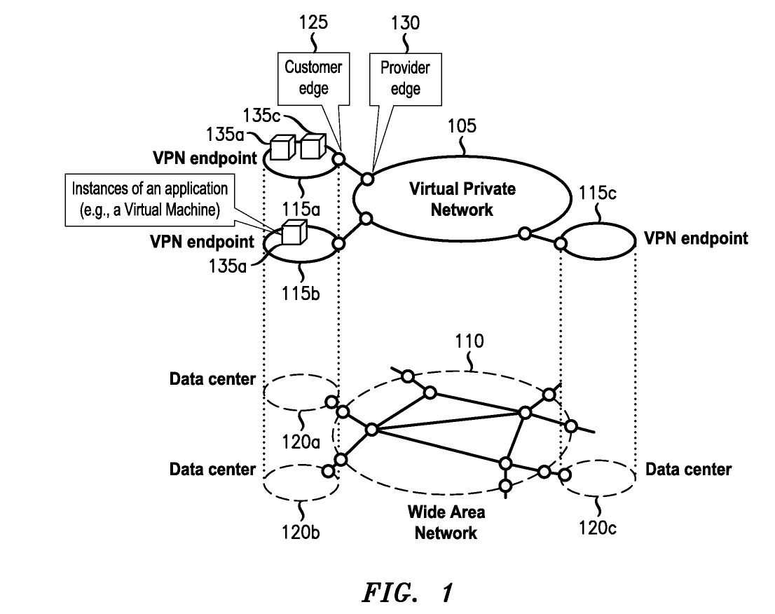

FIG. 1 illustrates an overview of a VPN that interconnects different VPN endpoints. The VPN may overlay and be implemented on wide area network (WAN) 110. The VPN may overlay other types of networks and include additional resources outside the WAN 110. (can't the VPN include resource from outside of the WAN? Why exclude that scenario). The VPN may be, for example, a level 2 (L2) VPN or a level 3 (L3) VPN. VPN endpoints 115a-c are connected to the VPN 105. The VPN endpoints may map to data center sites 120a-c. The VPN may use provider edge (PE) routers 130 to communicate with customer edge (CE) routers 125 in the VPN endpoints 115a-c. The underlying WAN may be, for example, an MPLS/IP core network or any other type of WAN.

The VPN endpoints 115a-c may use VMs 135a-c to implement application instances. These VMs 135a-c may operate on the VPN endpoints 115a-c. Various instances or portions of the application instances may communicate with one another using the VPN 105. The data center sites 120a-c that host the VPN endpoints 115a-c may include resources such as processing, storage, databases, memory, network access, etc. that may be used to implement the application on the cloud infrastructure. Going forward the term virtual machine will be used to indicate various instances of the cloud application as virtual machines are typically used to implement instances of cloud applications.

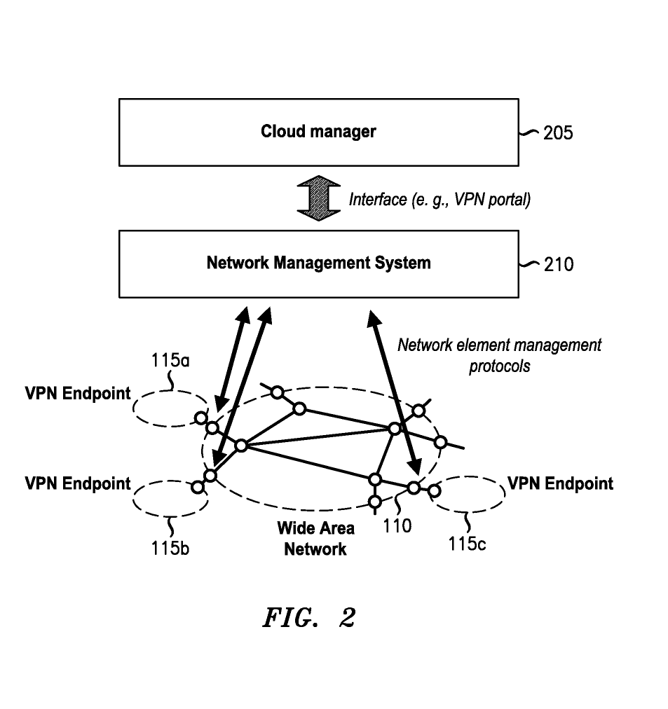

FIG. 2 illustrates an embodiment of the cloud scale out management system. The cloud scale out management system may include a cloud management system 205 that controls the deployment of a cloud application on a cloud infrastructure. The cloud management system 205 may receive a request to deploy an application on the cloud infrastructure. The cloud management system 205 then determines the resources needed to implement the cloud application. As demand for the cloud application increases, additional instances of the application may be initiated using virtual machines. As discussed above, when the resources needed to implement the various instances of the application exceed the capacity or a threshold capacity of the existing VPN endpoints/data centers, then the cloud management system 205 determines that additional cloud resources are necessary and seeks to obtain those resources. The cloud management system 205 may use an interface to the network, for instance by a VPN portal solution towards the network management system of the network that transports the VPN, or possibly a Software-Defined Networking (SDN) Controller.

The NMS 210 may manage the WAN 110 and the implementation of a VPN on the WAN 110. The NMS 210 may maintain a map of the network topology as well as status information regarding the various network nodes in the network, which may become VPN endpoints. Further, the NMS 210 may manage and maintain the various network connections between the network nodes as well as the network configuration. Such control may use control commands over network node management protocols, for example, SNMP or NETCONF. Also, the NMS 210 may provide performance and cost information relating to various aspects of the WAN 110 and VPNs implemented on the WAN 110. Further, instead of a single NMS 210, there may also be multiple parallel instances. Also, FIG. 2 only shows a single cloud application for a single customer. In reality, the network service provider may offer VPN services to different customers, each running potentially more than one cloud application.

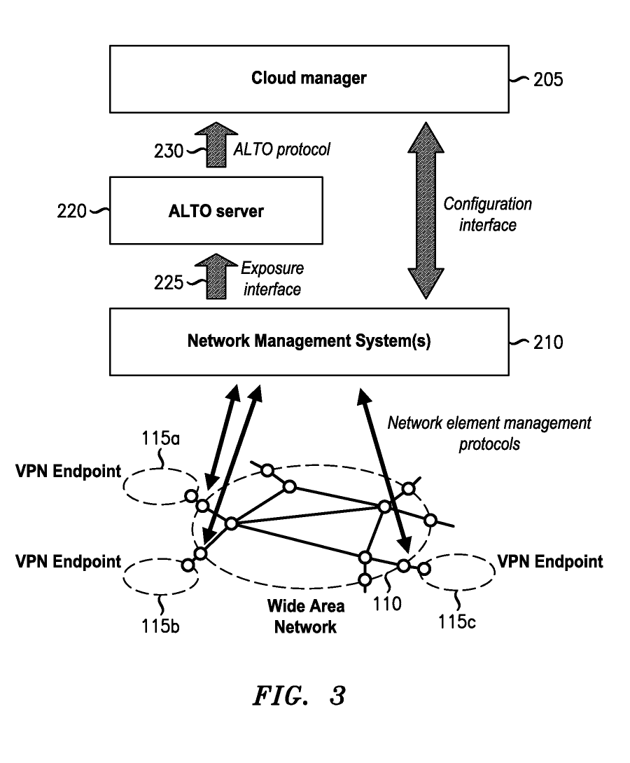

FIG. 3 illustrates another embodiment of the cloud scale out management system. The cloud scale out management system of FIG. 3 adds an Application-Level Traffic Optimization (ALTO) server 220 to the VPN management system of FIG. 2. The ALTO server 220 offers a standardized, simple interface to learn the network topology. The ALTO server 220 sits between the cloud manager 205 and the NMS 210. An exposure interface 225 between the ALTO server 220 and the NMS 210 provides information relating to the network including a topology map of the network and cost maps for the costs required by the system (e.g., delay, link bandwidth) to the ALTO server 220. The ATLO server 220 then provides network information to the cloud manager 205 using the ALTO protocol. This embodiment is particularly beneficial if the network is heterogeneous, if there are several network management systems 210, or if several application instances have to retrieve the topology. Instead of interfacing one or more network management systems 210, the overall objective of this invention can also be achieved by directly communication with individual network elements.

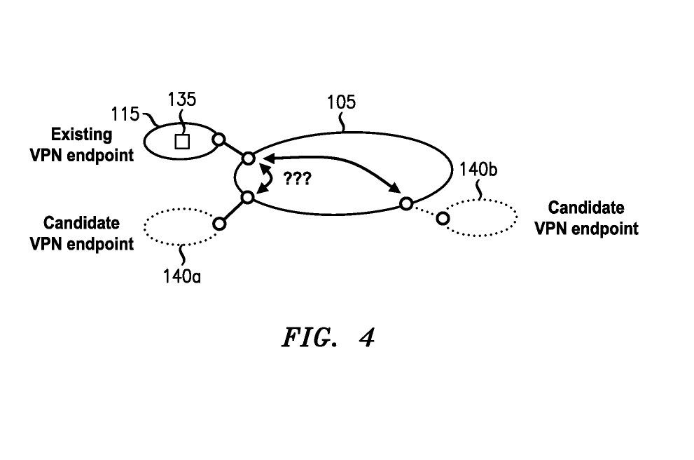

FIG. 4 illustrates a simple example of how a cloud scale out of VMs 135 already running a cloud application at one VPN endpoint 115 may be connected to a new, remote site over the VPN 105 that has to be expanded accordingly. Note that in one embodiment, the VPN 105 may already reach these other sites before the cloud scale out. These new, remote sites are candidate VPN endpoints 140a-b. In another embodiment, the candidate VPN endpoints 140a-b are not part of the VPN 105, and the VPN 105 must thus be reconfigured before connectivity is established. Also, in another embodiment the VPN configuration may be changed during the selection process (e.g., bandwidth reservations are modified). The selection of a target VPN endpoint in FIG. 4 is rather simple. The NMS 210 may determine whether the candidate VPN endpoints 140a-b fulfill the requirements needed by the VM 135, for example, minimum reserved network capacity, maximum delay, maximum geographic distance, etc. The NMS 210 may then select and rank the candidate VPN endpoints 140a-b that fulfills the requirements. The highest ranked candidate is selected as the new VPN endpoint that accommodates the cloud scale out. If no candidate VPN endpoint 140 meets the requirements, then the cloud scale out is not possible in this embodiment. Further, ranking of the candidate VPN endpoints 140a-b may also include evaluating other VPN endpoint performance characteristics, such as processing throughput, storage space, memory, etc.

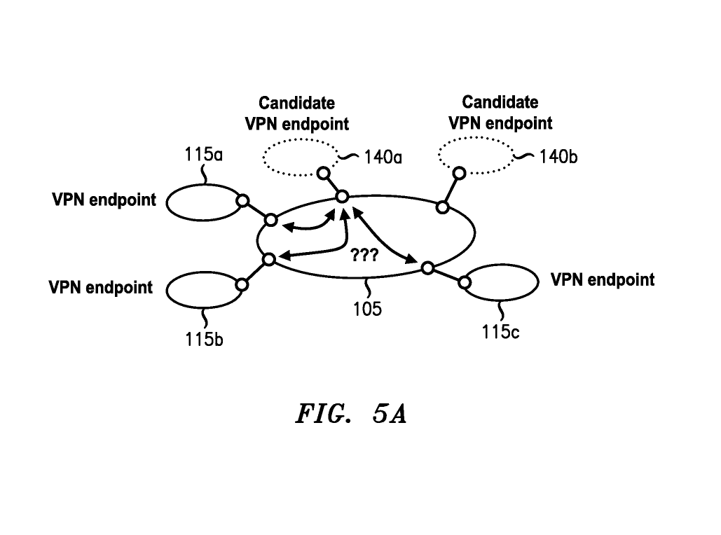

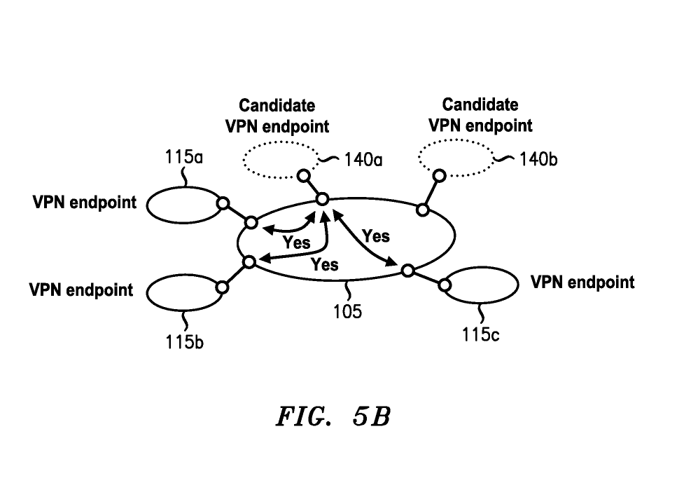

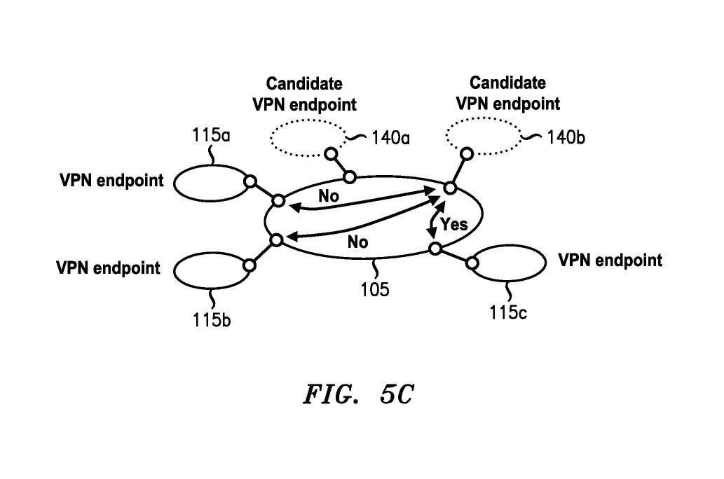

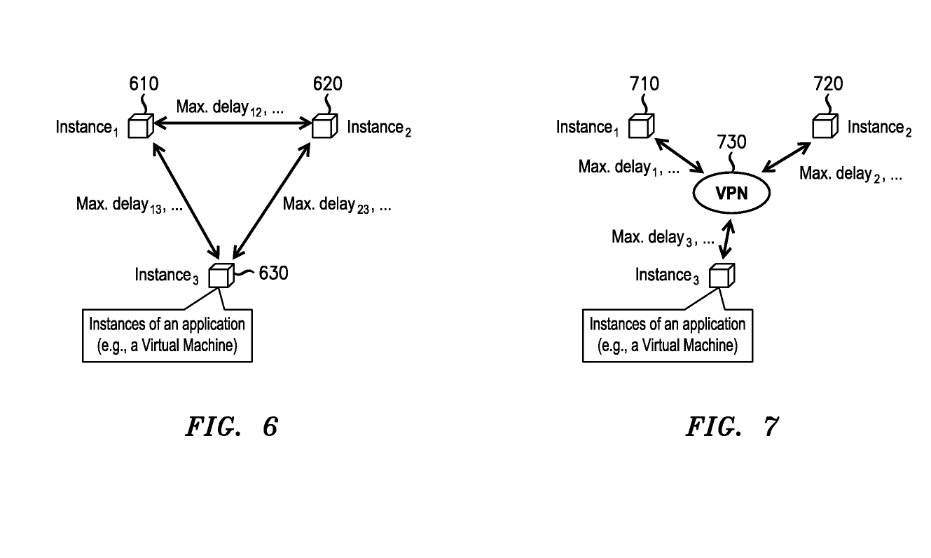

FIG. 5A illustrates an embodiment of a more complex example of a cloud scale out. In FIG. 5A, the VPN 105 includes three existing VPN endpoints 115a-c, and a cloud scale out to further sites is needed, e.g., because no additional VMs may be located at any of the VPN endpoints 115a-c that are already connected to the VPN 105. The communication characteristics between each pair of VPN endpoints may be different. This implies that the system has to determine for each pair of candidate VPN endpoints 140a-b and existing VPN endpoints 115a-c whether the communication requirements are fulfilled or not. Communication requirements may have different forms. For instance, a communication requirement may be of the type “the new VM (or VMs) must have at most 50 ms delay to a specific VM”. FIG. 6 illustrates the communication requirements for a cloud application using a VPN network. In this example, three different application instances 610, 620, 630, of the cloud application are illustrated. For example, a maximum communication delay between each of the application instances 610, 620, 630 may be specified (maximum delay₁₂, maximum delay₂₃, and maximum delay₁₃). Other communication requirements may also be specified in this manner.

Communication requirements may also be more general, e.g., the new VM (or VMs) must have at most 50 ms delay to all existing VMs. A simpler rephrasing may be the new VM (or VMs) must have at most 50 ms delay to the VPN. The latter type of requirement is simpler to specify for a user and thus an important use case. The latter type of requirements specifically benefit from the systems and methods described herein.

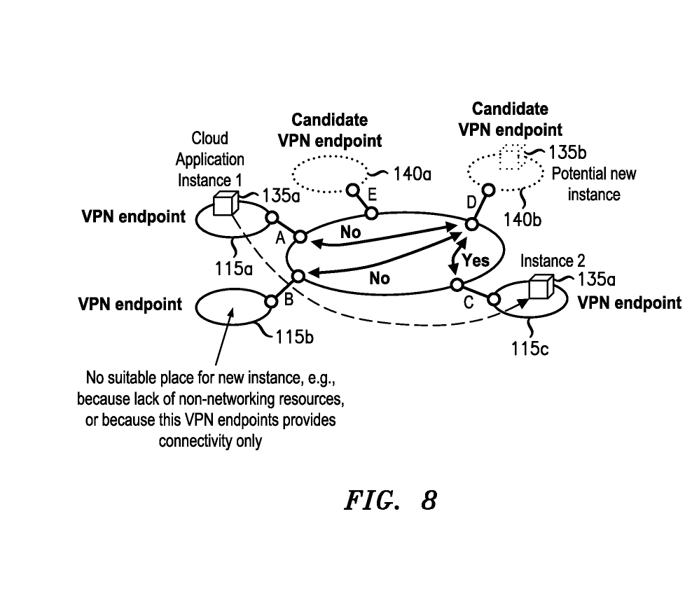

FIG. 7 illustrates the communication requirements for a cloud application using a VPN network. In this example, three different cloud instances 710, 720, 730, of the cloud application are illustrated as communicating via a VPN. In this case, an overall maximum communication delay may be specified that must be satisfied between each of the instances 710, 720, 730. Other communication parameters may also be specified in this manner.

Returning to FIG. 5A, when a cloud scale out is required, a set of candidate VPN endpoints 140a-b may be identified. The list of candidate VPN endpoints 140a-b may be determined by the NMS or the cloud manager depending on the availability of network topology and availability information to the NMS and the cloud manager. In the case where the cloud manager determines the list of candidate VPN endpoints 140a-b, if the NMS determines that there may be additional sites available for the cloud scale out, the NMS may add these additional sites to the list of candidate VPN endpoints. If a large number of candidate VPN endpoints is possible, the number of candidate VPN endpoints to consider may be limited based upon a fixed number or some other criteria, for example, site capacity, site location, etc. When the scale out is required, the cloud manager may provide a set of communication requirement, such as those described above, to the NMS. Other requirements may be included as well, for example, processing throughput, storage space, memory, etc. The NMS then evaluates the communication and other performance (if required) capabilities of the list of candidate VPN endpoints 140a-b. This performance capability is determined between each of the candidate VPN endpoints 140a-b and each existing VPN endpoint 115a-c. FIG. 5A shows arrows between candidate VPN endpoint 140a and existing VPN endpoints 115a-c indicating the network performance capabilities between each of these sites. The NMS may compare these network performance capabilities with the communication requirements provided by the cloud manager. FIGS. 5B and 5C describe two different results of this comparison.

FIG. 5B illustrates the case where all of the communication requirements are met by the candidate VPN endpoints. FIG. 5B shows the same network as FIG. 5A, but as shown each of the potential network connections between the candidate VPN endpoint 140a and existing VPN endpoints 115a-c meet the communication requirements. While not specifically shown, each of the potential network connections between the candidate VPN endpoint 140b and existing VPN endpoints 115a-c also meet the communication requirements. In this situation the NMS may indicate to the cloud manager that each of the candidate VPN endpoints 140a-b meets the communication requirements. The NMS may further rank the candidate VPN endpoints 140a-b based upon scoring the network performance of each candidate VPN endpoint based upon the communication link performance. It is also possible that such scoring may include other performance characteristics of the candidate VPN endpoints 140a-b as discussed above. The cloud manager may then use this information to select the best candidate(s) for satisfying the cloud scale out. Further, while this example illustrates two candidate VPN endpoints, any number of candidate VPN endpoint may be evaluated by the NMS and reported back to the cloud manager.

FIG. 5C illustrates the case where not all of the communication requirements are met by the candidate VPN endpoints. FIG. 5C shows the same network as FIG. 5A, but has shown only the potential network connection between the candidate VPN endpoint 140b and existing VPN endpoint 115c meets the communication requirements. The potential connections between candidate VPN endpoint 140b and existing VPN endpoints 115a-b do not meet the communication requirements. While not specifically shown, not all of the potential network connections between the candidate VPN endpoint 140a and existing VPN endpoints 115a-c may meet the communication requirements. In this situation the NMS may indicate to the cloud manager that only a portion of the potential links between candidate VPN endpoints 140a-b and the existing VPN endpoints 115a-c meet the communication requirements. The NMS may provide an indication of a partial match that includes the specific details regarding a subset (including the complete set) of the potential links that meet the communication requirements and optionally, which links do not. The NMS may further rank the candidate VPN endpoints 140a-b based upon scoring the network performance of each candidate VPN endpoint based upon the communication link performance. It is also possible that such scoring may include other performance characteristics of the candidate VPN endpoints 140a-b as discussed above. The cloud manager may then use this information to select the best candidate(s) for satisfying the cloud scale out. In this case, the cloud manager may have to select a specific candidate VPN endpoint and specific communication links to that candidate VPN endpoint from existing VPN endpoints in order to meet the communication requirements. As described above, while this example illustrates two candidate VPN endpoints, any number of candidate VPN endpoint may be evaluated by the NMS and reported back to the cloud manager.

FIG. 8 illustrates moving an existing instance of a cloud application from one existing VPN endpoint to another existing VPN endpoint. In the situation where a partial match occurs, the cloud manager may move cloud application instances 135 to run on VMs on existing VPN endpoints that correspond to the specific communication links identified in by the partial match. Specifically, a cloud application instance 135a on existing VPN endpoint 115a may be moved to existing VPN endpoint 115c because a potential communication link between existing VPN endpoint 115c and candidate VPN endpoint 140b meets the communication requirements of the cloud manager. Accordingly, the cloud manager may select candidate VPN endpoint 140b and implement a new cloud instance 135b to satisfy the cloud scale out, and the cloud manager may also move cloud instance 135a from existing VPN endpoint 115a to existing VPN endpoint 115c so that the communication requirements may be met.

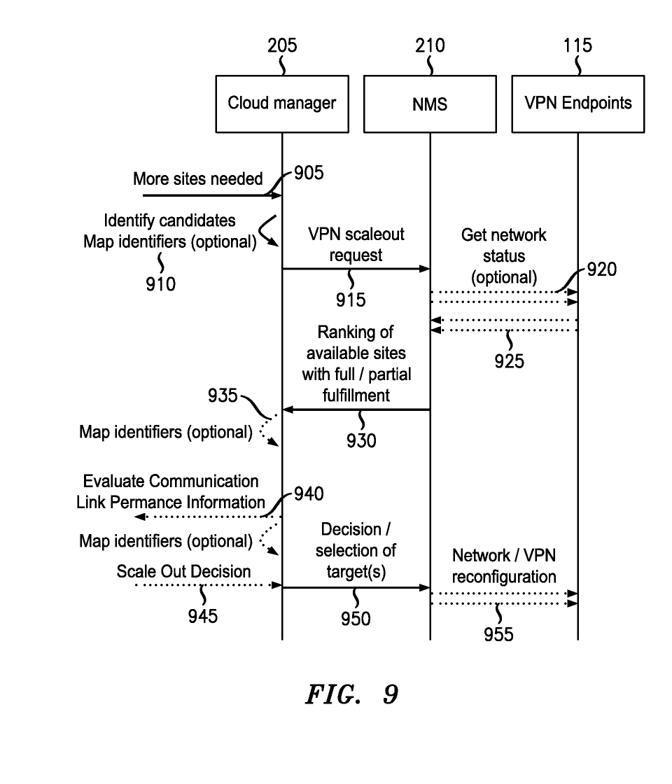

FIG. 9 illustrates an example message sequence for a cloud scale out. Cloud 205, NMS 210, and VPN endpoints 115 receive and exchange messages in order to affect a cloud scale out. First, cloud management system 205 may receive a message 905 indicating that additional cloud resources are needed in order to satisfy the requirements of a cloud application. Next, the cloud management system 205 may identify potential VPN endpoint candidates 910 that may be used to affect the cloud scale out. Also, at this time it may be necessary to map identifiers used by the cloud management system 205 for the VPN endpoints 115 to identifiers used by the NMS 210 for those same VPN endpoints 115. Alternatively, in some embodiments the NMS 210 may instead identify potential VPN endpoint candidates.

Management system 205 may send a VPN scale out request 915 to NMS 210. The VPN scale out request may include communication performance requirements that must be satisfied by VPN connections used by the cloud scale out. Also the VPN scale out request may include a list of candidate VPN endpoints 115 to evaluate for use in the cloud scale out. Next, the network management system 210 may request network status information from the VPN endpoints 115. In response, the VPN endpoints 115 may send network status information 925 to the network management system 210. The network status information may include the network communication performance of various existing and potential network links. Next network management system 210 may determine the potential VPN link performance for each of the potential candidate VPN endpoints 115. As described above, network management system 210 may rank the candidate VPN endpoints 115 potential VPN performance including determining whether the candidate VPN endpoint 115 is a full or partial match based on the communication requirements specified by the cloud management system 205. The NMS 210 then sends an indication including information regarding the communication link performance 930 for each candidate VPN endpoint 115 to the cloud management system 205. Further, the NMS 210 may rank the candidate VPN endpoints 115 as described above and provide 930 that ranking information to the cloud management system 205.

The cloud management system 205 receives the indication of communication link performance information from the NMS 210, and if needed, may map 935 identifiers used by the NMS 210 for the VPN endpoints 115 to identifiers used by the cloud management system 205 for those same VPN endpoints 115. The cloud management system 205 may then evaluate 940 the received communication link performance information and determine 945 potential data centers to use to affect the cloud scale out. The cloud management system 205 may include logic in order to automatically determine the VPN endpoints to select for the cloud scale out. Alternatively, a user may be presented information regarding the candidate VPN endpoints and their communication performance, and the user may choose the VPN endpoints 115 to use for the cloud scale out. In situations, where only partial matches are available, the cloud management system 205 may provide recommendations to move cloud application instances in order to utilize VPN endpoints 115 that provide only a partial match to the communication requirements.

The cloud manager 205 may then send 950 a list of selected VPN endpoints 115 to use for the cloud scale out to the NMS 210. The NMS 210 then establishes and configures 955 the VPN connections to the selected VPN endpoints 115.

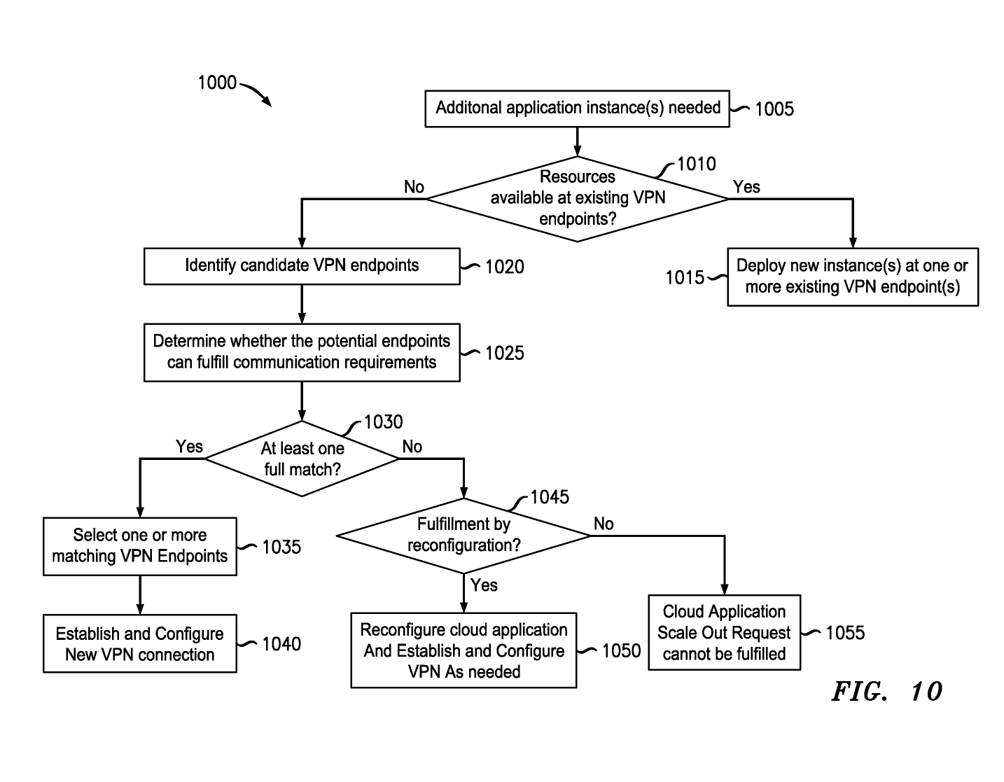

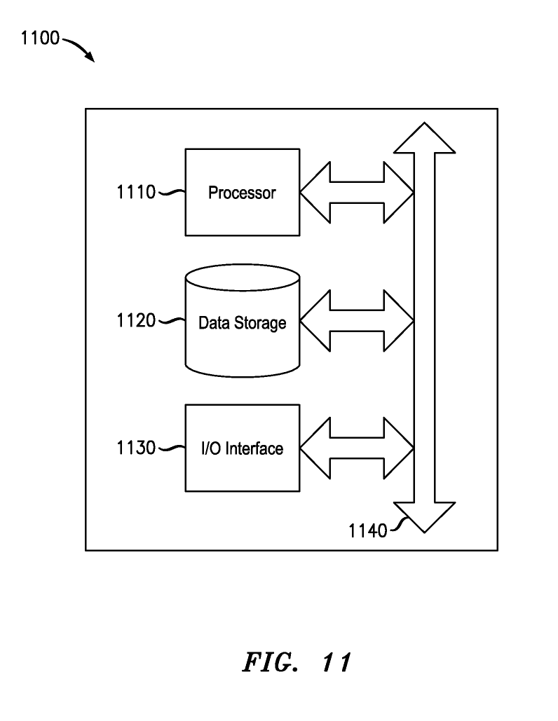

FIG. 10 illustrates a flow diagram for a method of scaling out VPN connections for a cloud application. Various steps of the method 1000 described below typically are be carried out by the cloud management system 205 and the NMS 210. First, the cloud manager determines that additional cloud application instances are needed 1005. Next, the cloud manager determines 1010 whether there are resources available at existing VPN endpoints to host the additional cloud application instance. If resources are available, then the cloud manager deploys 1015 the new cloud application instances at one or more of the existing VPN endpoints, and the method 1000 ends.

If resources are not available at existing VPN endpoints, then the cloud manager identifies 1020 potential new VPN endpoints and sends a list of potential new VPN endpoints to the NMS. Alternatively, as discussed above, the NMS may in some situations identify potential new VPN endpoints. Next, the NMS may determine 1025 whether the potential new VPN endpoint can fulfill the communication requirements and communicate this determination to the cloud manager. If at least one potential new VPN endpoint provides a full match (i.e., the potential new VPN endpoint satisfies all of the communication requirements), the cloud manager selects 1035 one or more matching VPN endpoints. The cloud manager may then communicate 1040 this selection to the NMS. The NMS may then establish and configure 1040 the new VPN connections.

If no potential new VPN endpoint provides a full match, then the cloud manager may determine 1045 if a reconfiguration of the cloud application instances, such as when a partial match occurs, may fulfill the cloud application scale out. If so, then the cloud manager may reconfigure 1050 the cloud application. Then, the NMS will establish and configure 1050 the VPN as needed, and the method 1000 ends. If a reconfiguration of the cloud application instances will not satisfy the communication requirements, then the cloud application scale out request cannot be fulfilled 1055, and the method 1000 ends.

FIG. 11 illustrates a hardware diagram of an exemplary cloud node. The exemplary cloud node 1100 may correspond to the exemplary cloud manager 205, NMS 210, or VPN endpoint 115 of FIG. 2. The network node 300 may include a processor 1110, a data storage 1120, an input/output (I/O) interface 1130, and system bus 1140.

The processor 1110 may control the operation of the network node 300 and cooperate with the data storage 320 and the I/O interface 330, via a system bus 1140. As used herein, the term “processor” will be understood to encompass a variety of devices such as microprocessors, field-programmable gate arrays (FPGAs), application-specific integrated circuits (ASICs), and other similar processing devices.

The data storage 1120 may store program data such as various programs useful in performing the functions of the network node. For example, the data storage 320 may store cloud management instructions, network management instruction, etc. Such programs may carry out the various functions of the cloud manager 205, the NMS 210, or the VPN endpoints 115 as described above.

The I/O interface 1130 may cooperate with the processor 1110 to support communications over one or more communication channels. For example, the I/O interface 1130 may include a user interface, such as a keyboard and monitor, and/or a network interface, such as one or more Ethernet ports.

In some embodiments, the processor 1110 may include resources such as processors/CPU cores, the I/O interface 1130 may include any suitable network interfaces, or the data storage 1120 may include memory or storage devices. Moreover the network node 1100 may be any suitable physical hardware configuration such as: one or more servers or blades consisting of components such as processor, memory, network interfaces or storage devices. In some of these embodiments, the network node 1100 may include network resources that are remote from each other.

In some embodiments, the network node 1100 may include one or more virtual machines. In some of these embodiments, a virtual machine may include components from different physical machines or be geographically dispersed. For example, the data storage 1120 and the processor 1110 may reside in two different physical machines. In some embodiments, the network node 1100 may be a general purpose computer programmed to perform the methods described herein. When processor-executable programs are implemented on a processor 1110, the program code segments combine with the processor to provide a unique device that operates analogously to specific logic circuits.

In various methods described and/or recited in this application, various steps of methods may be performed in a sequential manner, a parallel manner, or in a partially parallel manner.

It should be appreciated by those skilled in the art that any block diagrams herein represent conceptual views of illustrative circuitry embodying the principles of the invention.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be effected while remaining within the spirit and scope of the invention. Accordingly, the foregoing disclosure, description, and figures are for illustrative purposes only and do not in any way limit the invention, which is defined only by the claims.

What is claimed is:

1. A method for scaling out a cloud application, the method comprising:
receiving a virtual private network (VPN) scale out request at a network management system (NMS), the scale out request including communication requirements from a cloud computing manager;
determining the value of communication parameters corresponding to the communication requirements for a set of potential VPN endpoints;
determining that only a portion of the set of potential VPN endpoints meet the communication requirements based upon the communication parameters; and
sending an indication to the cloud manager that only a portion of the set of potential VPN endpoints meet the communication requirements.

2. The method of claim 1, wherein the indication that only a portion of the set of potential VPN endpoints meet the communication requirements further includes the value of communication parameters corresponding to the communication requirements for the set of potential VPN endpoints.

3. The method of claim 1, further comprising:
ranking the portion of the set of potential VPN endpoints that meet the communication requirements; and
sending the set of potential VPN endpoints to the cloud manager based on the ranking.

4. The method of claim 3, wherein ranking the portion of the set of potential VPN endpoints that meet the communication requirements is based on other VPN endpoint performance parameters.

5. The method of claim 1, receiving, by the NMS, from the cloud manager a request to configure a VPN connection to a selected VPN endpoint selected by the cloud manager.

6. The method of claim 1, further comprising:
ranking the portion of the set of potential VPN endpoints that meet the communication requirements;
receiving, by the cloud manager, an indication that only a portion of the set of potential VPN endpoints that meet the communication requirements and the ranking of the set of potential VPN endpoints;
selecting, by the cloud manager, a VPN endpoint from the portion of the set of potential VPN endpoints; and
sending, by cloud manager, a request to configure a VPN connection to the selected VPN endpoint.

7. The method of claim 6, wherein selecting, by the cloud manager, a VPN endpoint from the portion of the set of potential VPN endpoints includes receiving user input via a user interface coupled to the cloud manager.

8. The method of claim 6, wherein selecting, by the cloud manager, a VPN endpoint from the portion of the set of potential VPN endpoints includes using an automated prioritization method.

9. The method of claim 6, further comprising reconfiguring, by the cloud manager, the cloud configuration bases upon the selected VPN endpoint.
A network management system (NMS) for configuring a virtual private network (VPN) for a scale out of a cloud application, the NMS comprising:
a network interface;
a memory; and
a processor in communication with the memory, the processor being configured to:
receive a VPN scale out request at a network management system (NMS), the scale out request including communication requirements from a cloud computing manager;
determine the value of communication parameters corresponding to the communication requirements for a set of potential VPN endpoints;
determine that only a portion of the set of potential VPN endpoints meet the communication requirements based upon the communication parameters; and
send an indication to the cloud manager that only a portion of the set of potential VPN endpoints meet the communication requirements.

10. The NMS of claim 9, wherein the indication that only a portion of the set of potential VPN endpoints meet the communication requirements further includes the value of communication parameters corresponding to the communication requirements for a set of potential VPN endpoints.

11. The NMS of claim 9, wherein the processor is further configured to:
rank the portion of the set of potential VPN endpoints that meet the communication requirements; and
send the set of potential VPN endpoints to the cloud manager based on the ranking.

12. The NMS of claim 11, wherein ranking the portion of the set of potential VPN endpoints that meet the communication requirements is based on other VPN endpoint performance parameters.

13. The NMS of claim 9, wherein the processor is further configured to receive from the cloud manager a request to configure a VPN connection to a VPN endpoint selected by the cloud manager.

14. A non-transitory machine-readable storage medium encoded with instructions for execution by a network management system for scaling out a cloud application, the medium comprising:
instructions for receiving a virtual private network (VPN) scale out request at a network management system (NMS), the scale out request including communication requirements from a cloud computing manager;
instructions for determining the value of communication parameters corresponding to the communication requirements for a set of potential VPN endpoints;
instructions for determining that only a portion of the set of potential VPN endpoints meet the communication requirements based upon the communication parameters; and
instructions for sending an indication to the cloud manager that only a portion of the set of potential VPN endpoints meet the communication requirements.

15. The non-transitory machine-readable storage medium of claim 14, wherein the indication that only a portion of the set of potential VPN endpoints meet the communication requirements further includes the value of communication parameters corresponding to the communication requirements for a set of potential VPN endpoints.

16. The non-transitory machine-readable storage medium of claim 14, further comprising:
instructions for ranking the portion of the set of potential VPN endpoints that meet the communication requirements; and
instructions for sending the set of potential VPN endpoints to the cloud manager based on the ranking.

17. The non-transitory machine-readable storage medium of claim 16, wherein ranking the portion of the set of potential VPN endpoints that meet the communication requirements is based on other VPN endpoint performance parameters.

18. The non-transitory machine-readable storage medium of claim 14, further comprising instructions for receiving from the cloud manager a request to configure a VPN connection to a selected VPN endpoint selected by the cloud manager.
